(19) United States
(12) Patent Application Publication
(10) Pub. No.: US 2013/0093340 A1
(43) Pub. Date: Apr. 18, 2013

(54) LIGHT EMITTING APPARATUS AND LED DRIVING METHOD USING THE SAME

(71) Applicant: SAMSUNG ELECTRONICS CO., LTD., Suwon-si (KR)

(72) Inventors: Mamoru HORINO, Suwon (KR); Yoshio FUJIMURA, Suwon (KR); Masami NEI, Suwon (KR)

(73) Assignee: SAMSUNG ELECTRONICS CO., LTD., Suwon-si (KR)

(21) Appl. No.: 13/654,630

(22) Filed: Oct. 18, 2012

(30) Foreign Application Priority Data
Oct. 18, 2011 (KR) 10-2011-0106479
Mar. 8, 2012 (KR) 10-2012-0023818

(51) Int. Cl. H05B 37/00

(52) U.S. Cl. 315/193

(57) ABSTRACT

Provided are a light emitting apparatus and a LED driving method using the same. The light emitting apparatus may include: a light source including first to nth LED groups driven by direct current (DC) power and sequentially connected in series; and a driving controller detecting a current flowing in an output terminal of the light source and changing the number of LED groups driven in the light source when the detected current is outside of a predetermined current range.

### CROSS-REFERENCE TO RELATED APPLICATIONS

This application claims priority from Korean Patent Application No. 10-2011-0106479, filed on Oct. 18, 2011 in the Korean Intellectual Property Office, and Korean Patent Application No. 10-2012-0023818, filed on Mar. 8, 2012 in the Korean Intellectual Property Office, the disclosures of which are incorporated herein by reference in their entireties.

### BACKGROUND

1. Field

Apparatuses and methods consistent with exemplary embodiments relate to a light emitting apparatus and a LED driving method using the same.

2. Description of the Related Art

In general, a light emitting device (LED) refers to a semiconductor device capable of implementing various colors of light by configuring a light emitting source through modifications of a compound semiconductor material, such as gallium arsenide (GaAs), aluminum gallium arsenide (AlGaAs), gallium nitride (GaN), aluminum gallium indium phosphide (InGaAlP), or the like. LEDs have been widely used in various application areas, such as television (TV) screens, computer monitors, general lighting devices, automobiles, and the like, due to advantages thereof. Examples of such advantages include excellent monochromatic peak wavelengths and optical efficiency, miniaturizability, environmental-friendliness, low power consumption, and the like. Furthermore, LEDs have been gradually expanded for use in various application fields.

An LED has characteristics in which current is exponentially-functionally increased with respect to voltage applied to both terminals thereof. Thus, in the case in which a lighting apparatus using an LED as a light source is applied to a commercial alternating current (AC) power source used in homes, offices, outdoor lighting systems, or the like, it may be common to use a constant current circuit generating a constant current. That is, since an LED may be sensitively varied with respect to voltage applied to the LED, an apparatus and a method for controlling a current flowing into an LED are required in order to use AC power having large variations in voltage as input power.

### SUMMARY

Aspects of one or more exemplary embodiments provide a high efficiency, low cost light emitting apparatus and an LED driving method using the same.

According to an aspect of an exemplary embodiment, there is provided a light emitting apparatus, including: a light source including first to nth LED groups driven by direct current (DC) power and sequentially connected in series; and a driving controller detecting a current flowing in an output terminal of the light source and changing the number of LED groups driven in the light source when the detected current is outside of a predetermined current range.

The driving controller may detect the current flowing in the output terminal of the light source to generate an input signal, and compare the input signal with a reference signal to determine whether the detected current is outside of the predetermined current range.

The driving controller may include: a comparator comparing an input signal generated by detecting the current flowing in the light source with the reference signal and outputting a control signal when the detected current is outside of the predetermined current range; a switch controller receiving the control signal output from the comparator and outputting a signal for changing the number of driven LED groups when receiving the control signal; and a switch connected to at least a portion of output terminals of the first to nth LED groups and turned on or turned off by the signal output from the switch controller.

The comparator may output an upper limit control signal or a lower limit control signal when the current detected in the output terminal of the light source is outside of the predetermined current range.

The switch controller may output a signal for controlling the number of driven LED groups to be increased when receiving the upper limit control signal and controlling the number of driven LED groups to be decreased when receiving the lower limit control signal.

The driving controller may further include a flicker prevention circuit allowing the switch to be forcibly turned off when the upper limit control signal is not output during a certain period in a section from a time at which the upper limit control signal is initially output to a time at which the lower limit control signal is initially output, in a driving cycle of the DC power.

The comparator may include: a first comparator comparing the input signal with a first reference signal and outputting an upper limit control signal when the input signal is greater than the first reference signal; and a second comparator comparing the input signal with a second reference signal and outputting a lower limit control signal when the input signal is lower than the second reference signal.

The first and second comparators may be comparators or operational amplifiers (OP amps), the first reference signal may be inputted to an inverting input terminal of the first comparator, while the input signal may be inputted to an non-inverting input terminal of the first comparator, and the input signal may be inputted to an inverting input terminal of the second comparator, and the second reference signal may be inputted to an non-inverting input terminal of the second comparator.

The light emitting apparatus may further include: a voltage regulator receiving a part of the DC power and outputting a certain level of voltage; and a plurality of resistors connected in series between an output terminal of the voltage regulator and a ground, wherein the first and second reference signals may be set to be voltages divided by the plurality of resistors.

The comparator may further include a current detection resistor connected between the output terminal of the light source and a ground, and the input signal may be generated in a voltage form by the current detection resistor.

The switch may include first to (n−1)th switches, respectively connected between output terminals of first to (n−1)th LED groups and the current detection resistor.

The switch controller may control the switch to be turned on or turned off.

The light emitting apparatus may further include a rectifier converting alternating current (AC) power inputted from the outside into the DC power.

The rectifier may include a bridge diode.

The first to nth LED groups may each include at least one LED.

At least one of the first to nth LED groups may include a plurality of LEDs, the plurality of LEDs being electrically connected in series or in parallel, or in series and in parallel configurations.

According to an aspect of another exemplary embodiment, there is provided an LED driving method, including: detecting a current flowing in first to nth LED groups sequentially connected in series to rectified DC power; setting a driving current range for controlling the current flowing in the first to nth LED groups; and controlling the number of driven LED groups to be changed at a time at which the current detected in the first to nth LED groups is outside of the driving current range.

The driving current range may be set to have an upper limit of current and a lower limit of current.

In the controlling of the number of driven LED groups to be changed, the number of driven LED groups may be controlled to be increased when the current flowing in the first to nth LED groups is greater than the upper limit, while the number of driven LED groups may be controlled to be decreased when the current flowing in the first to nth LED groups is lower than the lower limit.

In the controlling of the number of driven LED groups to be changed, the current detected in the first to nth LED groups may be controlled to be instantly decreased or increased at the time at which the current detected in the first to nth LED groups is outside of the driving current range.

The current detected in the first to nth LED groups may be controlled to be instantly decreased when the current flowing in the first to nth LED groups is greater than the upper limit, while the current detected in the first to nth LED groups may be controlled to be instantly increased when the current flowing in the first to nth LED groups is lower than the lower limit.

The LED driving method may further include controlling the number of driven LED groups to be forcibly changed when the detected current is within the driving current range during a certain period in a section from a time at which the current flowing in the first to nth LED groups is initially greater than the upper limit to a time at which the current flowing in the first to nth LED groups is initially lower than the lower limit, in a driving cycle of the DC power.

In the controlling of the number of driven LED groups to be forcibly changed, the number of driven LED groups may be controlled to be increased.

The first to nth LED groups may be controlled such that the first to nth LED groups are sequentially turned on and then nth to the first LED groups are sequentially turned off, in a driving cycle of the DC power.

In a section in which the first to nth LED groups are sequentially turned on from the first LED group to the nth LED group, when the nth LED group becomes turned-on, a (n−1)th LED group may be in a turned-on state.

The current flowing in the first to nth LED groups may be detected in a voltage form.

The current flowing in the first to nth LED groups may be detected in an output terminal of the nth LED group.

The LED driving method may further include converting alternating current (AC) power inputted from the outside into the DC power.

### BRIEF DESCRIPTION OF THE DRAWINGS

The above and/or other aspects, features and other advantages will be more clearly understood from the following detailed description taken in conjunction with the accompanying drawings, in which:

FIG. 1 is a view schematically showing a light emitting apparatus according to an exemplary embodiment;

FIG. 2 is a view showing an example of the light emitting apparatus according to the embodiment shown in FIG. 1;

FIGS. 3A, 3B, and 3C are views schematically showing voltage and current waveforms applicable to a light emitting apparatus according to an exemplary embodiment;

FIG. 4 is a view schematically showing a light emitting apparatus according to another exemplary embodiment;

FIGS. 5A, 5B, and 5C are views showing voltage and current waveforms of a light source unit capable of being driven by the light emitting apparatus according to an exemplary embodiment;

FIGS. 6A and 6B are views for explaining operations of the light emitting apparatus shown in FIGS. 4 and 5; and

FIG. 7 is a flowchart of an LED driving method according to an exemplary embodiment.

### DETAILED DESCRIPTION OF EXEMPLARY EMBODIMENTS

Exemplary embodiments will now be described in detail with reference to the accompanying drawings.

Exemplary embodiments may, however, be embodied in many different forms and should not be construed as being limited to the exemplary embodiments set forth herein. Rather, these exemplary embodiments are provided so that this disclosure will be thorough and complete, and will fully convey the scope of exemplary embodiments to those skilled in the art. In the drawings, the shapes and sizes of components are exaggerated for clarity. The same or equivalent elements are referred to by the same reference numerals throughout the specification.

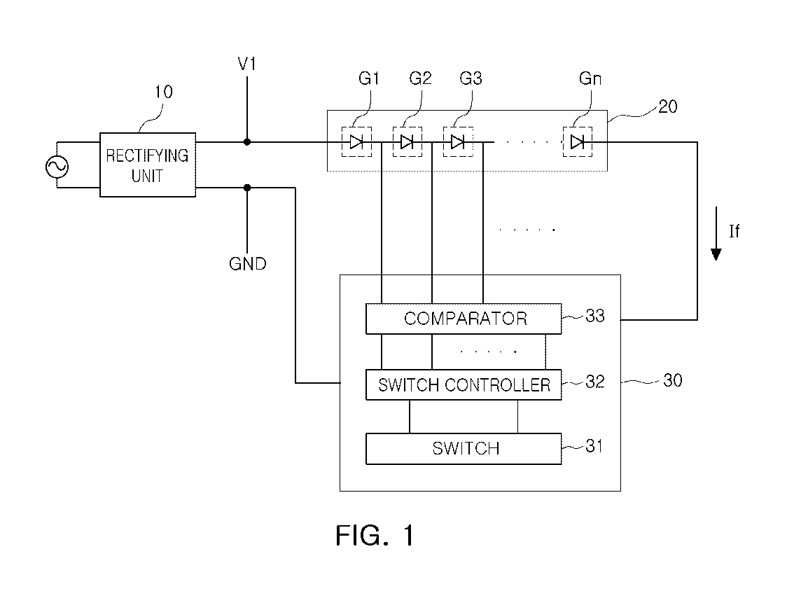

FIG. 1 is a view schematically showing a light emitting apparatus according to an exemplary embodiment.

Referring to FIG. 1, a light emitting apparatus according to the present exemplary embodiment may include a light source unit 20 (e.g., light source including circuitry) including first to nth LED groups G1, G2 . . . Gn driven by direct current (DC) power and sequentially connected in series, and a driving control unit 30 (e.g., driving controller including circuitry) detecting a current flowing in an output terminal of the light source unit 20 and changing the number of the LED groups driven in the light source unit 20 when the current is outside of a predetermined current range.

In the present exemplary embodiment, the light emitting apparatus may further include a rectifying unit 10 (e.g., rectifier including circuitry) converting alternating current (AC) power input from the outside into the DC power, wherein the DC power may be input to the light source unit 20.

The rectifying unit 10 may rectify AC power (for example, a commercial alternating current (AC) power of 220VAC or 100VAC) applied from the outside. In an output voltage rectified by the rectifying unit 10, a high potential side may be connected to the light source unit 20 and a low potential side may be connected to the driving control unit 30. In the present exemplary embodiment, the low potential side may refer to a reference potential, that is, a ground GND. Thus, current may flow from the rectifying unit 10 to the ground GND through the light source unit 20. The rectifying unit 10 full-wave rectifies external AC power.

Meanwhile, the DC power referenced in the description of the present exemplary embodiment may refer to DC power in which voltage has a magnitude varied over time while having a constant polarity in a broader sense, as well as DC power in which voltage has a constant magnitude over time. In addition, it may be presumed that a voltage-varied reference frequency is 100 Hz or more, such that human eyes may not recognize flickering.

The light source unit 20 may include the first to nth LED groups G1, G2 . . . Gn, sequentially connected in series, and each of the first to nth LED groups G1, G2 . . . Gn may be connected to the driving control unit 30. The first to nth LED groups G1, G2 . . . Gn may be devices each including at least one LED as a light source. When a plurality of first to nth LED groups are provided, a plurality of LEDs may be configured to have various electrical connection relationships in which they are connected in series or in parallel, or in series and in parallel configurations, such that the plurality of LEDs may be driven as a single unit. FIG. 1 illustrates that each of the first to nth LED groups G1, G2 . . . Gn configuring the light source unit 20 includes a single LED for convenience of description. However, it is understood that another exemplary embodiment is not limited thereto, and the plurality of LEDs may be configured to have various electrical connection relationships.

The driving control unit 30 may control at least a portion of the first to nth LED groups G1, G2 . . . Gn configuring the light source unit 20, to be driven according to a magnitude of a voltage V1 of the power rectified by the rectifying unit 10.

The driving control unit 30 may increase the number of LED groups driven in a section in which the voltage V1 of the rectified power has an increased magnitude, while decreasing the number of the LED groups driven in a section in which the voltage V1 of the rectified power has a decreased magnitude, to thereby enable the maximum number of drivable LEDs to be driven according to the magnitude of voltage V1, which is a periodically variable input voltage. In this case, operations of increasing and decreasing the number of the driven LED groups may be controlled by detecting the current flowing in the light source unit 20 and comparing the detected current with a reference signal to maintain the detected current within a certain range.

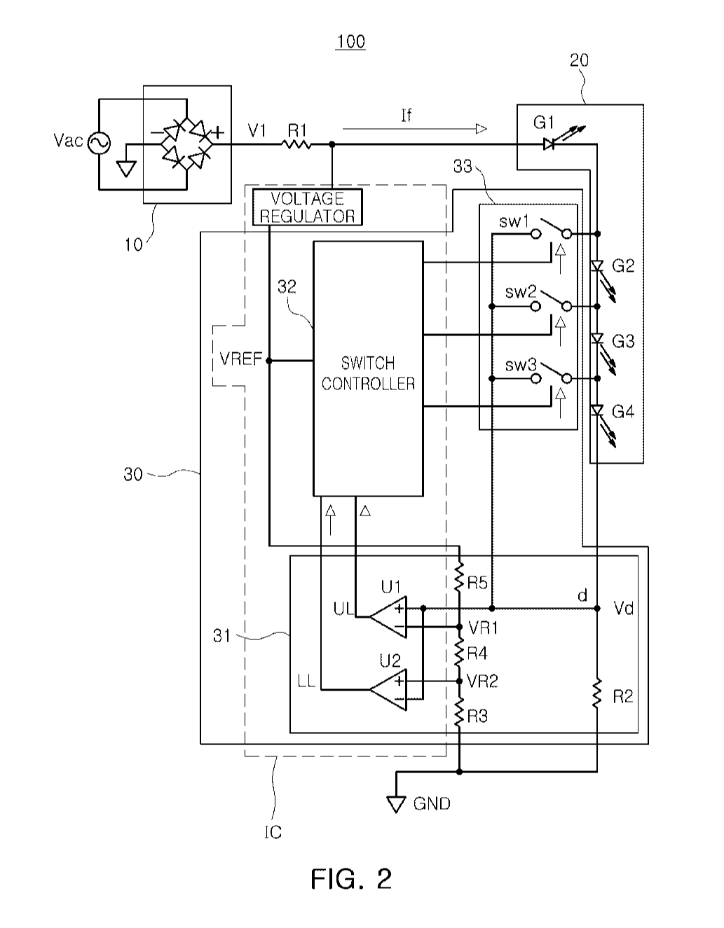

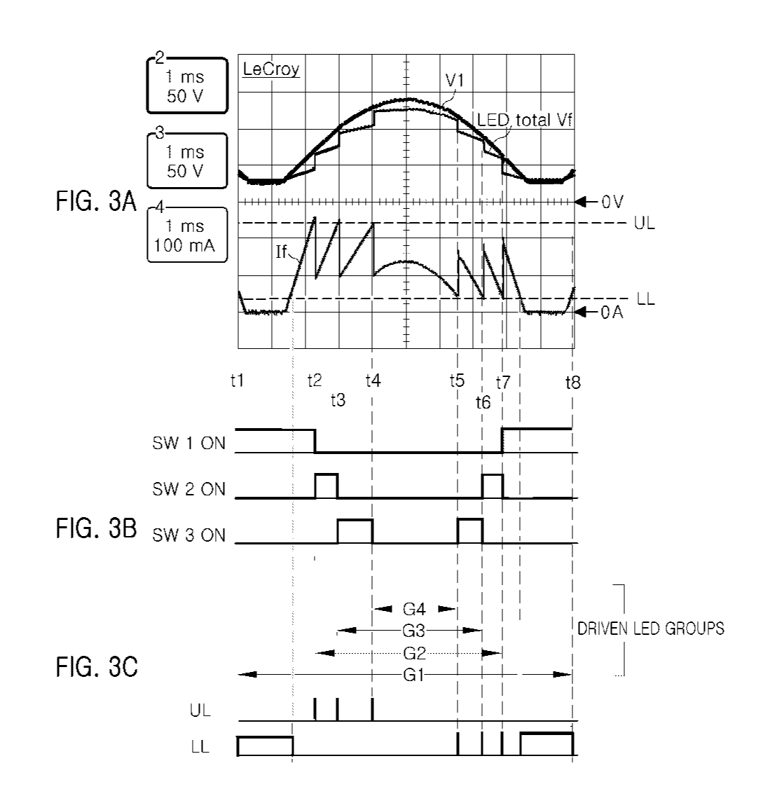

Hereinafter, operations of the driving control unit 30 will be described in detail with reference to FIGS. 2 and 3.

FIG. 2 is a view showing an example of the light emitting apparatus 100 according to the exemplary embodiment shown in FIG. 1. FIGS. 3A, 3B, and 3C are views showing voltage and current waveforms applicable to the light emitting apparatus according to an exemplary embodiment.

Referring to FIG. 2, a light emitting apparatus 100 may include the rectifying unit 10 converting AC power input from the outside into DC power, the light source unit 20 including first to nth LED groups driven by the DC power and sequentially connected in series, and the driving control unit 30 detecting a current flowing in the output terminal of the light source unit 20 and changing the number of the LED groups driven in the light source unit 20 when the current is outside of a predetermined current range.

A bridge diode may be applied to the rectifying unit 10 in order to convert AC power Vac input from the outside into DC power. The voltage V1 of the rectified power may exhibit a full-wave rectified sinusoidal wave form, and a driving current If may flow from an output terminal of the rectifying unit 10 to the ground GND through the light source unit 20.

The light source unit 20 may include first to fourth LED groups G1, G2, G3 and G4 sequentially connected in series to the output terminal of the rectifying unit 10. FIG. 2 illustrates that each of the first to fourth LED groups G1, G2, G3 and G4 includes a single LED. However, it is understood that one or more other exemplary embodiments are not limited thereto and each LED group may include a plurality of LEDs connected in series or in parallel, or in series and in parallel configurations.

In an LED driving circuit having a general commercial AC power input thereto, except for a boost circuit of a switching mode power supply (SMPS), when a plurality of LEDs are connected in series to the output terminal of the rectifying unit 10, which includes a bridge diode, current may not flow in a section in which the voltage V1 output from the rectifying unit 10 is smaller than the entire driving voltage of the plurality of LEDs. That is, in a full-wave rectified sine wave, only in a section exhibiting a voltage greater than a driving voltage Vf, all LEDs are driven, while in a section exhibiting a voltage smaller than the driving voltage Vf, all LEDs may not be driven.

However, in the light emitting apparatus 100 according to the present exemplary embodiment, at least a portion of the first to nth LED groups G1, G2 . . . Gn are sequentially turned-on by a switch of the driving control unit 30 according to a magnitude of the voltage V1 of the rectified power, such that the section in which all LEDs are not driven is minimized to thereby improve driving efficiency.

In addition, a small-capacity capacitor may be disposed in the output terminal of the rectifying unit 10 to thereby allow for the elimination of a section in which the driving current If becomes 0, while regulations on power and current harmonics are satisfied.

To this end, the driving control unit 30 may include: a comparator 31 connected to the output terminal of the light source unit 20, comparing an input signal generated by detecting the current flowing in the light source unit 20 with the reference signal, and outputting a control signal when the detected current is outside of the predetermined current range; a switch controller 32 receiving the control signal output from the comparator 31 and outputting a signal for controlling the number of driven LED groups to be increased or decreased; and a switch 33 connected to at least a portion of output terminals of the first to nth LED groups G1, G2 . . . Gn, here, the first to fourth LED groups G1, G2, G3 and G4 are turned-on or turned-off by the signal output from the switch controller 32.

In this case, the comparator 31 may output an upper or a lower limit control signal when the current detected in output terminal of the light source unit 20 is outside of the predetermined current range, and the switch controller 32 may control the number of driven LED groups to be increased when receiving the upper limit control signal, and control the number of driven LED groups to be decreased when receiving the lower limit control signal.

The comparator 31 may include at least first and second comparators U1 and U2 comparing the input signal generated by detecting the current flowing in the light source unit 20 with the reference signal, and comparators or operational amplifiers (OP amps) may be applied to the first and second comparators U1 and U2.

The first comparator U1 may compare the input signal with a first reference signal VR1 and output an upper limit control signal UL when the input signal is greater than the first reference signal VR1, and the second comparator U2 may compare the input signal with a second reference signal VR2 and output a lower limit control signal LL when the input signal is lower than the second reference signal VR2.

In this case, the first reference signal VR1 may be input to an inverting input terminal (−) of the first comparator U1, and the second reference signal VR2 may be input to an non-inverting input terminal (+) of the second comparator U2. Each of the first and second reference signals VR1 and VR2 may have a fixed value and may be set to be a part of a voltage VREF stabilized by a voltage regulator. Although not specifically illustrated, the switch controller 32 may be driven by using a part of a voltage output from the voltage regulator.

The voltage regulator may be connected to the output terminal of the rectifying unit 10 and output a constant level of voltage by receiving a part of the voltage V1 of the rectified power. A plurality of resistors R3, R4 and R5 may be connected between an output terminal of the voltage regulator and the ground GND. In this case, the first and second reference signals VR1 and VR2 input to the first and second comparators U1 and U2 may be set to be voltages divided by the plurality of resistors R3, R4 and R5.

Specifically, in the exemplary embodiment illustrated in FIG. 2, the first reference signal VR1 may be set to be

$$\frac{R 3 + R 4}{R 3 + R 4 + R 5} VREF ,$$

and in a similar manner, the second reference signal VR2 may be set to be

$$\frac{R 3}{R 3 + R 4 + R 5} VREF .$$

In this case, the first and second reference signals VR1 and VR2 may set an upper limit current If (UL) and a lower limit current If (LL) flowing in the light source unit 20.

An upper limit UL and a lower limit LL of the driving current If, that is, the upper limit current If (UL) and the lower limit current If (LL), detected in an output terminal d of the light source unit 20 may be set according to magnitudes of the resistors R3, R4 and R5 connected between the first and second comparators U1 and U2 and the ground GND, and a resistor R2 connected between the output terminal of the light source unit 20 and the ground GND, as follows. Here, the upper limit UL and the lower limit LL of the driving current If may be set in consideration of the driving voltage of the LED groups of the light source unit 20, as set forth in equations (1) and (2) below:

$$\begin{matrix}If ( UL ) = \frac{1}{R 2} \frac{R 3 + R 4}{R 3 + R 4 + R 5} VREF & ( equation 1 ) \\ If ( LL ) = \frac{1}{R 2} \frac{R 3}{R 3 + R 4 + R 5} VREF & ( equation 2 )\end{matrix}$$

The comparator 31 may output the upper limit control signal UL to the switch controller 32 through the first comparator U1 when If>If(UL), and in this case, the switch controller 32 may control the switch to increase the number of driven LED groups according to the upper limit control signal UL.

Conversely, the comparator 31 may output the lower limit control signal LL to the switch controller 32 through the second comparator U2 when If<If(LL), and in this case, the switch controller 32 may control the switch to decrease the number of driven LED groups according to the lower limit control signal LL.

Specifically, the first comparator U1 may receive a voltage Vd detected from the current flowing in the light source unit 20 through a non-inverting input terminal (+) thereof, and receive the first reference signal VR1 through the inverting input terminal (−) thereof to compare magnitudes thereof, thereby providing the upper limit control signal UL to the switch controller 32 when the detected voltage Vd is greater than the first reference signal VR1.

Meanwhile, the second comparator U2 may receive the voltage Vd detected from the current flowing in the light source unit 20 through an inverting input terminal (−) thereof, and receive the second reference signal VR2 through the non-inverting input terminal (+) thereof to compare magnitudes thereof, thereby providing the lower limit control signal LL to the switch controller 32 when the detected voltage Vd is lower than the second reference signal VR2.

The switch controller 32 may receive the upper or lower limit control signal UL or LL output from the comparator 31 and control the number of driven LED groups to be increased when receiving the upper limit control signal UL from the first comparator U1 while, conversely, controlling the number of driven LED groups to be decreased when receiving the lower limit control signal LL from the second comparator U2. In this case, a shift resistor, a counter, a decoder, or the like may be applied to the switch controller 32, without being limited thereto.

The switch 33 may be connected to at least a portion of output terminals of the first to nth LED groups G1, G2 . . . Gn and turned-on or turned-off by the signal output from the switch controller 32, thereby changing a path of the current flowing in the light source unit 20.

As illustrated in FIG. 2, the switch 33 may include first to (n−1)th switches SW1, SW2 . . . SWn−1 respectively connected between output terminals of the first to (n−1)th LED groups G1, G2 . . . Gn−1 among the first to nth LED groups G1, G2 . . . Gn and the resistor R2, which is a current detection resistor, or the ground GND. Also, another active or passive element other than the current detection resistor may be further included between the output terminals of the LED groups and the ground GND.

For example, when a second switch SW2 is closed and first and third switches are opened, the driving current If may pass through the second switch SW2 and the resistor R2 through the first and second LED groups G1 and G2 and flow to the ground GND. In this case, if the voltage Vd=IfxR2 detected in the comparator 31 is present between the first and second reference signal VR1 and VR2, states of the first to third switches SW1, SW2, and SW3 may be maintained as usual.

Meanwhile, when the voltage Vd detected in the comparator 31 is greater than the first reference signal VR1, the second switch SW2 is opened and the third switch SW3 is closed, such that the driving current If may pass through the resistor S2 from the first to third LED groups G1, G2 and G3 and flow to the ground GND. Conversely, when the voltage Vd detected in the comparator 31 is lower than the second reference signal VR2, the second switch SW2 is opened and the first switch SW1 is closed, such that the driving current If may pass through the resistor S2 from the first LED group G1 and flow to the ground GND.

FIGS. 3A, 3B, and 3C are views showing voltage and current waveforms applicable to a light emitting apparatus according to an exemplary embodiment. Specifically, FIGS. 3A, 3B, and 3C show voltage and current waveforms and operations of the LED groups and switches in the case of being applied to the light emitting apparatus 100 of FIG. 2, based on a cycle of the voltage V1 of the rectified power.

Two waveforms shown in an upper portion of FIG. 3A refer to waveforms of the voltage V1 full-wave rectified by the rectifying unit 10 and a driving voltage LED total Vf of the first to fourth LED groups G1, G2, G3, and G4, and a waveform shown in a lower portion of FIG. 3A refers to the driving current If flowing in the light source unit 20, according to an exemplary embodiment. FIG. 3B refers to turn-on or turn-off operations of the first to third switches SW1, SW2, and SW3 of the switch 33, according to an exemplary embodiment. FIG. 3C shows the signals detected in the first and second comparators U1 and U2 of the comparator 31 and the correspondingly driven LED groups, according to an exemplary embodiment.

Hereinafter, operations and driving methods of the voltage V1 of the full-wave rectified power in one cycle will be described in detail with reference to FIGS. 2, 3A, 3B, and 3C. Here, for convenience of description and easy understanding of exemplary embodiments, it is assumed that the voltage V1 of the full-wave rectified power is used only to drive the light source unit 20, and power consumed for driving other circuits may be significantly low, and accordingly not considered.

However, the light emitting apparatus according to one or more other exemplary embodiments is not limited to exemplary embodiments in which the voltage V1 of the rectified power is used only to drive the light source unit 20, and it will be obvious to a person having ordinary skill in the art that a part of the voltage V1 of the rectified power may be used as power for driving other driving circuits.

An LED driving method according to an exemplary embodiment may include: detecting a current flowing in the first to nth LED groups G1, G2 . . . Gn sequentially connected in series to the rectified DC power; setting a driving current range for controlling the current flowing in the first to nth LED groups G1, G2 . . . Gn; and controlling the number of driven LED groups to be changed when the current detected in the first to nth LED groups G1, G2 . . . Gn is outside of a predetermined current range.

In view of operations of section t1˜t2, the driving current If does not flow (If=0) in an initial state in which voltage is at a low level, and in this case, the voltage Vd detected from the driving current If may have a smaller value than the second reference signal VR2 of the second comparator U2 (Here, the reference signal of the second comparator U2 may be set to have an appropriate value using a resistor as described above). Thus, the second comparator U2 may output the lower limit control signal LL to the switch controller 32 and, accordingly, the switch controller 32 may control the first switch SW1 to be turned on. Once the first switch SW1 is turned on, the state of the first switch SW1 is not changed, even if the lower limit control signal LL is detected after that. As the voltage V1 of the power is gradually increased, the driving current If starts to flow, the voltage Vd detected from the driving current If has a value greater than the first reference signal VR1 and lower than the second reference signal VR2 (VR1<Vd<VR2), and even in this case, the first switch SW1 is maintained in the closed state.

The driving current If is increased simultaneously with the increase in voltage V1 of the power. When the voltage Vd detected from the driving current If is greater than the first reference signal VR1 of the first comparator U1, that is, at time t2, the first comparator U1 may output the upper limit control signal UL to the switch controller 32, and the switch controller 32 may enable the first switch SW1 to be turned off and the second switch SW2 to be turned on according to the upper limit control signal output from the first comparator U1, thereby increasing the number of driven LED groups.

In this case, the driving current If flowing from the first LED group to the ground GND through the first switch SW1 and the resistor R2 may flow from the first and second LED groups G1 and G2 and the second switch R2 to the ground GND through the resistor R2. In addition, at the time at which the first switch SW1 is turned-off and the second switch SW2 is turned-on (time t2), the driving voltage Vf is increased by the second LED group G2, such that the driving current If is instantly decreased.

Hereinafter, it is assumed that driving voltages of the first to fourth LED groups are identical to be Vf0. The driving current If at time t2 is decreased by the second LED group G2 which is additionally driven, and particularly, is changed from

$$If = \frac{V 1 - Vf 0}{R 1 + R 2}$$

$$to$$

$$If = \frac{V 1 - 2 Vf 0}{R 1 + R 2} .$$

Then, in view of operations of section t2˜t3, as the voltage V1 of the rectified power is increased in a state in which the driving current If is decreased, the driving current If and the voltage Vd detected from the driving current If are also gradually increased.

When the voltage Vd detected from the driving current If is greater than the first reference signal VR1 (Vd>VR1), that is, at time t3, the first comparator U1 may output the upper limit control signal UL to the switch controller 32, and the switch controller 32 may output a signal, enabling the second switch SW2 to be turned off and the third switch SW3 to be turned on in order to drive more LEDs. In this case, the driving current If flowing from the first and second LED groups G1 and G2 to the ground GND through the resistor R2 may flow from the first to third LED groups G1, G2 and G3 to the ground GND through the resistor R2, and the driving current If is instantly decreased in accordance with the increase in the driving voltage Vf of LEDs at time t3. That is, the driving current If at time t3 is changed from

$$If = \frac{V 1 - 2 Vf 0}{R 1 + R 2}$$

$$to$$

$$If = \frac{V 1 - 3 Vf 0}{R 1 + R 2} .$$

Then, in view of operations of section t3˜t4, when the voltage Vd detected from the decreased driving current If is present between the first reference signal VR1 and the second reference signal VR2, that is, when VR2<Vd<VR1, the driving current If may flow through the first to third LED groups G1, G2 and G3 and, accordingly, the first to third LED groups G1, G2 and G3 may be operated.

In a similar manner to the previous case, when the driving current If is gradually increased and the voltage Vd detected from the driving current If is greater than the first reference signal VR1 (time 4), the switch controller 32 enables the third switch SW3 to be turned off and, correspondingly, enables all switches to be turned off, such that the driving current If may flow through the first to fourth LED groups G1, G2, G3 and G4. That is, the driving current If at time t4 is changed from

$$If = \frac{V 1 - 3 Vf 0}{R 1 + R 2}$$

$$to$$

$$If = \frac{V 1 - 4 Vf 0}{R 1 + R 2} .$$

Then, in view of operations of section t4˜t5, the third switch SW3 is turned off at time t4, and when the voltage Vd detected from the driving current If in the comparator 31 is present between the first reference voltage VR1 and the second reference voltage VR2, the third switch SW3 is maintained in the turned-off state.

In this case, the driving current If may flow from the first to fourth LED groups G1, G2, G3 and G4 to the ground GND through the resistor R2, and may be gradually decreased as the voltage V1 of the rectified power gradually decreases after having reached a peak.

When the voltage Vd detected from the driving current If is lower than the second reference signal VR2 of the second comparator U2 in accordance with the decrease in the driving current If, that is, at time t5, the second comparator U2 may output the lower limit control signal LL to the switch controller 32, and the switch controller 32 may enable the third switch SW3 to be turned on in order to decrease the number of driven LED groups. In this case, the fourth LED group G4 is turned off and only the first to third LED groups G1, G2, and G3 are operated.

At this time, since the number of driven LEDs is instantly decreased, the driving voltage Vf of the LEDs is decreased, such that the driving current If is temporarily increased and, in particular, the driving current If at time t5 may be changed from

$$If = \frac{V 1 - 4 Vf 0}{R 1 + R 2}$$

$$to$$

$$If = \frac{V 1 - 3 Vf 0}{R 1 + R 2} .$$

Then, in view of operations of section t5˜t6, the increased driving current If is gradually decreased as the voltage V1 of the rectified power decreases after having reached the peak. In this case, when the voltage Vd detected from the driving current If is present between the first reference voltage VR1 and the second reference voltage VR2 (VR2<Vd<VR1), the states of the first to third switches SW1, SW2 and SW3 may be maintained intact. When the voltage Vd detected from the driving current If has a smaller value than the second reference signal VR2 in accordance with the decrease in the driving current If (time t6), the second comparator U2 may output the lower limit control signal LL to the switch controller 32.

In this case, the switch controller 32 enables the third switch SW3 in the turned-on state to be turned off and the second switch SW2 in the turned-off state to be turned on in order to drive fewer LEDs according to the lower limit control signal LL output from the second comparator U2, such that only the first and second LED groups are driven.

Then, in view of operations of section t6˜t7, as the third switch SW3 is turned off and the second switch SW2 is turned on at time t6, the driving voltage Vf of the LEDs is decreased, such that the driving current If is instantly increased. Specifically, the driving current If at time t6 may be changed from

$$If = \frac{V 1 - 3 Vf 0}{R 1 + R 2}$$

$$to$$

$$If = \frac{V 1 - 2 Vf 0}{R 1 + R 2} .$$

In a similar manner as in section t5˜t6, the increased driving current If is decreased simultaneously with the decrease in the voltage V1 of the rectified power. The second switch SW2 is turned off and the first switch SW1 is turned on at the time (time t7) in which the second comparator U2 outputs the lower limit control signal LL to the switch controller 32, and at this time, the second LED group G2 may not be operated. In this case, the driving current If at time t7 may be changed from

$$If = \frac{V 1 - 2 Vf 0}{R 1 + R 2}$$

$$to$$

$$If = \frac{V 1 - Vf 0}{R 1 + R 2} .$$

Then, in view of operations of section t7˜t8, only the first LED group G1 is driven by the operations of first and second switches SW1 and SW2 at time t7, and when the voltage V1 of the rectified power is further lowered and even the first LED group G1 is unable to be driven, the first LED group G1 is turned off.

Since the voltage V1 of the rectified power rises again after having passed a lowest point thereof, the operations of section t7˜t8 are repeated thereafter.

In the present exemplary embodiment, any one of the first to third switches SW1, SW2, and SW3 constituting the switch 33 may be turned on or all of the first to third switches SW1, SW2, and SW3 may be turned off, and two or more switches may not be simultaneously turned on. However, when an nth switch is turned on, whether remaining switches going after an (n+1)th switch are tuned on or turned off may not affect operations of a driving circuit.

As illustrated in FIG. 3B, as the voltage V1 of the rectified power is increased, the first to third switches SW1, SW2, and SW3 are sequentially turned on and then all of the first to third switches SW1, SW2, and SW3 are turned off. The voltage V1 of the rectified power decreases after having passed the peak, and the first switch SW3, the second switch SW2, and the first switch SW1 are sequentially turned-on.

Accordingly, the first to fourth LED groups G1, G2, G3 and G4 are sequentially turned on in a section in which the voltage V1 of the rectified power is increased (herein, “sequentially turned on” indicates that the second to fourth LED groups G2, G3 and G4 are turned-on in addition to the first LED group G1, rather than indicating that the second LED group G2 is turned on after the first LED group G1 is turned off). The first to fourth LED groups G1, G2, G3 and G4 are sequentially turned off in a section in which the voltage V1 of the rectified power is decreased.

According to the present exemplary embodiment, the driving current If flowing in the rectifying unit 10 may be detected based on variances in the voltage V1 of the rectified power, and a predetermined upper limit current If (UL) and a predetermined lower limit current If (LL) may be compared with the detected driving current If to control the switch, thereby controlling the number of driven LEDs. In other words, it is possible to control the number of driven LEDs such that a different number of LEDs are driven according to sections through only a switch and a resistor, without a separate current driving circuit for driving currents of different magnitudes according to individual sections. Thus, an LED driving circuit having a simplified configuration and decreased power consumption to thereby allow for improved power efficiency may be provided.

Unlike the present exemplary embodiment, a method of controlling switches in accordance with respective driving voltages of the first to fourth LED groups G1, G2, G3 and G4, according to another exemplary embodiment, may be used in order to drive a different number of LED groups among the first to fourth LED groups G1, G2, G3 and G4 in accordance with a magnitude of the voltage V1 of the rectified power.

Specifically, when the voltage V1 of the rectified power is present between a driving voltage of the first LED group G1 and a driving voltage of the first and second LED groups G1 and G2, the switches may be controlled in such a manner that the first switch SW1 is turned on to thereby allow the driving current If to flow to the ground GND only through the first LED group G1, and the first switch SW1 is turned off and the second switch SW2 is turned on at the time (time t2) in which the voltage V1 of the rectified power is greater than the driving voltage of the first and second LED groups G1 and G2 to thereby allow the driving current If to flow to the ground GND through the first and second LED groups G1 and G2.

However, in this case, since respective LEDs have tolerance in terms of driving voltage, a switch control time is designed in consideration of this fact. That is, provided that an average driving voltage of the LED groups refers to Vf (typical) and a maximum driving voltage within tolerance refers to Vf (max), when a threshold voltage of a switch is set based on the average driving voltage Vf (typical), a case in which the LED groups are not turned on according to a switching operation may be generated.

For example, assume a case in which, when the second switch SW2 is turned on and the first and second LED groups G1 and G2 are driven in FIG. 2, if the voltage V1 of the rectified power reaches the average driving voltage Vf (typical) of the first to third LED groups G1, G2 and G3, the third switch SW3 is controlled to be turned on. In this case, when a driving voltage of the third LED group G3 has the maximum driving voltage within tolerance Vf (max), even in the case in which the third switch SW3 is turned on, the voltage V1 of the rectified power may be lower than the maximum driving voltage within tolerance Vf (max) of the third LED group G3, and consequently, the first to third LED groups G1, G2 and G3 may not be driven.

Accordingly, in order to prevent this phenomenon, a threshold voltage of a switch is designed based on the maximum driving voltage within tolerance Vf (max) of the first to fourth LED groups G1, G2, G3 and G4. That is, when the number of switches is n, a threshold voltage for driving an nth LED group is set to be n×Vf(max) (in the case in which first to nth LED groups each include a single LED having a driving voltage Vf), and power loss Vf(max)−Vf(min) caused by tolerance in terms of driving voltage is increased in proportion to the number of switches, such that power efficiency may be decreased with the increase in the number of switches.

In addition, since the respective switches are controlled in accordance with driving voltages, the number of comparators correspond to the number of switches and, also, a circuit for detecting turn-on or turn-off states of the respective switches and a current driving circuit for driving different currents according to states of the switches are used, such that a circuit configuration is complicated and power for driving respective circuits is additionally required.

Meanwhile, a circuit part for current-driving is embedded in an integrated circuit (IC) in order to miniaturize a driving circuit. However, a driving current may flow into the integrated circuit (IC) to cause high power consumption within the IC, whereby thermal disadvantages may occur and integrated circuit (IC) power consumption has limitations. Thus, it may be difficult to operate the driving circuit in environments having high ambient temperatures and it may be difficult for the driving circuit as a single unit to correspond to high power.

However, in the light emitting apparatus according to the present exemplary embodiment, illustrated in FIG. 2, respective switches may be automatically controlled by detecting a magnitude of the driving current If flowing in the light source unit 20, rather than being directly controlled by detecting states of the respective switches according to driving voltage magnitudes of individual LED groups.

That is, since the switches may not be controlled in consideration of the driving voltage magnitudes of individual LED groups, power loss due to an increase in the number of switches may not occur, such that a high-efficiency light emitting apparatus may be provided.

In addition, the light emitting apparatus may include only two comparators U1 and U2, comparing the driving current If with the upper limit current If(UL) and the lower limit current If(LL) or OP amps, rather than requiring a separate comparator or OP amp for each of the first to nth LED groups. Meanwhile, a plurality of LED groups may be controlled such that the plurality of LED groups are individually driven through a simple circuit including a switch and a resistor without a separate current driving circuit for driving a predetermined current with respect to each of the first to nth LED groups.

In addition, in the present exemplary embodiment, since the driving current If does not flow into the integrated circuit (IC), power consumption and heat generation may be lowered. Thus, an apparatus advantageous in operating in high temperature environments may be provided. Furthermore, since a resistor and a switch (for example, a field effect transistor (FET)) are located outwardly of the integrated circuit (IC), an apparatus having a high degree of freedom of design and corresponding to power having a relatively high range may be provided.

When the same power is required with respect to 200V-based and 100V-based external commercial power sources, the driving current If in the 100V-based external commercial power source may be increased twofold as compared to the 200V-based external commercial power source. Thus, costs may increase and a circuit size may be enlarged in order to apply the same integrated circuit (IC) to the 200V-based and 100V-based external commercial power sources.

However, in the present exemplary embodiment, since the driving current If does not flow into the integrated circuit (IC), designing an integrated circuit (IC) applicable to both 200V-based and 100V-based power sources may be facilitated.

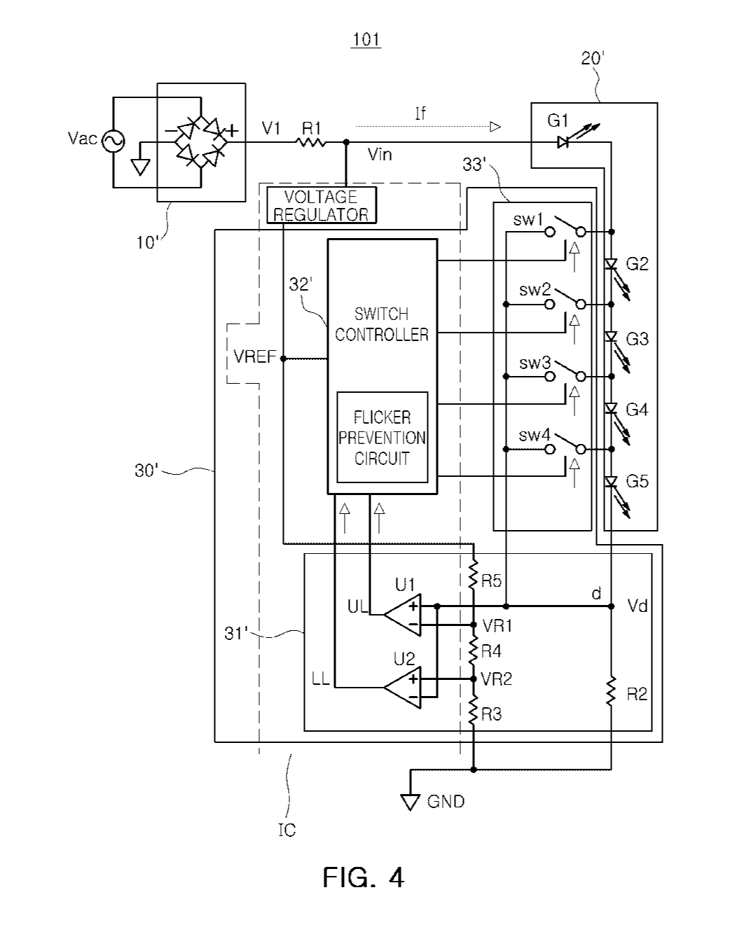

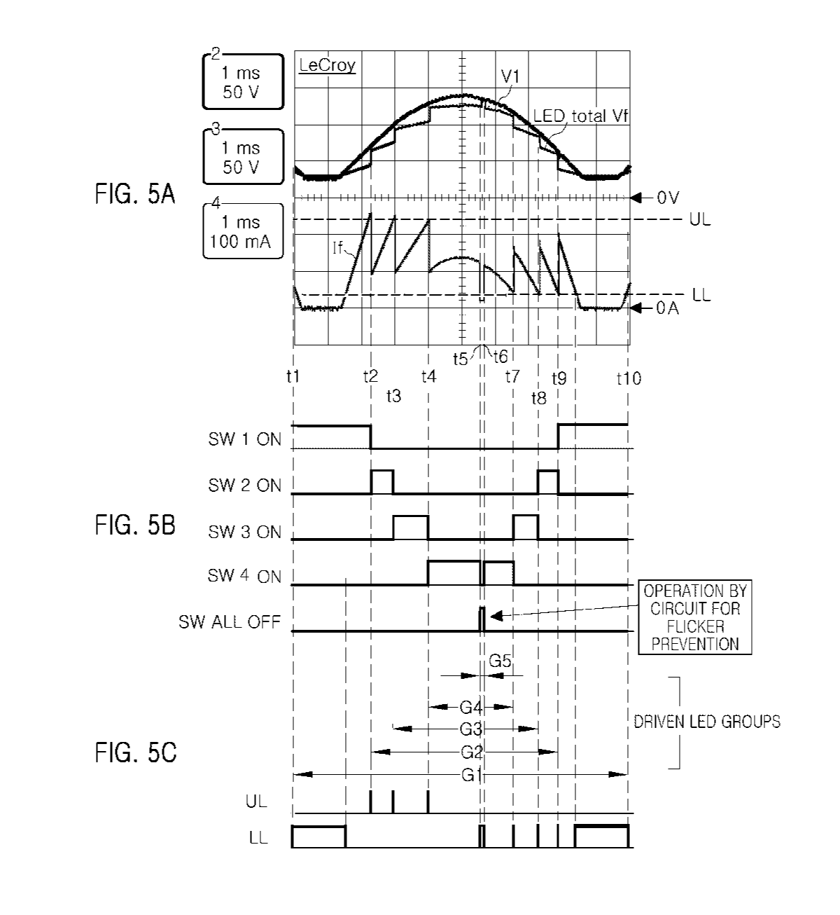

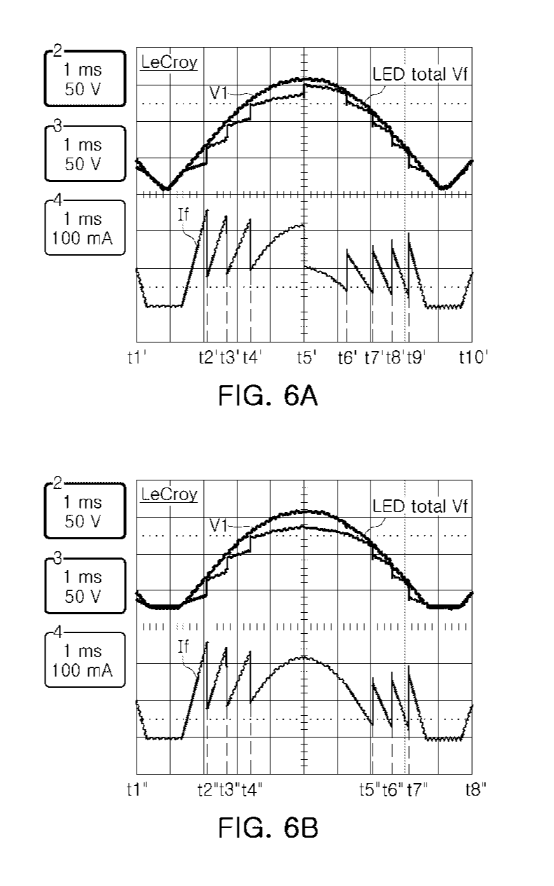

FIG. 4 is a view schematically showing a light emitting apparatus 101 according to another exemplary embodiment. FIGS. 5A, 5B, and 5C are views showing voltage and current waveforms, capable of being driven by the light emitting apparatus 101 shown in FIG. 4. FIGS. 6A and 6B are views showing operations of the light emitting apparatus shown in FIGS. 4, 5A, 5B, and 5C.

Referring to FIG. 4, the light emitting apparatus 101 may include a rectifying unit 10′ converting AC power input from the outside into DC power, a light source unit 20′ including first to fifth LED groups G1, G2, G3, G4 and G5 driven by the DC power and sequentially connected in series, and a driving control unit 30′ controlling a current flowing in the first to fifth LED groups.

The driving control unit 30′ may include: a comparator 31′ comparing an input signal generated by detecting a current flowing in the light source unit 20′ with a reference signal and outputting a switch control signal; a switch controller 32′ receiving the switch control signal output from the comparator 31′ and controlling switch turn-on or turn-off; and a switch 33′ connected to output terminals of the first to fifth LED groups G1, G2, G3, G4 and G5 and changing a driving current path by the signal received from the switch controller 32′.

The driving control unit 30′ of the light emitting apparatus 101 according to the present exemplary embodiment may further include a flicker prevention circuit.

Referring to FIGS. 4, 5A, 5B, and 5C, the light emitting apparatus 101 according to the present exemplary embodiment may be driven in a similar manner to the light emitting apparatus 100 described with reference to FIGS. 2, 3A, 3B, and 3C, except for section t5˜t6.

Specifically, section t1˜t4 in voltage and current waveforms of FIGS. 5A, 5B, and 5C is similar to section t1˜t4 in voltage and current waveforms of FIGS. 3A, 3B, and 3C, and section t7˜t10 in voltage and current waveforms of FIGS. 5A, 5B, and 5C may be driven in a similar manner to section t5˜t8 in voltage and current waveforms of FIGS. 3A, 3B, and 3C. Since operational differences are present only in section t3˜t7, including a peak in the voltage V1 of the rectified power, only operations of section t3˜t7 will be described herein.

First, in section t3˜t4, when the voltage Vd detected from the decreased driving current If is present between the first reference signal VR1 and the second reference signal VR2, that is, when VR2<Vd<VR1, the driving current If may flow through the first to third LED groups G1, G2 and G3.

When the driving current If is gradually increased with an increase in the voltage V1 of the rectified power and the voltage Vd detected from the driving current If is greater than the first reference signal VR1 (time t4), the switch controller 32′ enables the third switch SW3 to be turned off and the fourth switch SW4 to be turned on, such that the driving current If may flow through the first to fourth LED groups G1, G2, G3 and G4.

Then, in view of operations of section t4˜t7 except for section t5˜t6, the fourth switch SW4 is turned on at time t4, and when the voltage Vd detected from the driving current If in the comparator 31 is present between the first reference voltage VR1 and the second reference voltage VR2, the fourth switch SW4 is maintained in the turned on state.

Compared to the waveforms of FIGS. 3A, 3B, and 3C, FIGS. 5A, 5B, and 5C are different in that all switches are in a turned-off state in FIG. 3C when the third switch SW3 is turned off, while the third switch SW3 is turned off and the fourth switch SW4 is turned on in FIG. 5C. However, FIGS. 3A, 3B, and 3C and 5A, 5B, and 5C are similar in terms of operations for driving the fourth LED group G4.

When the voltage V1 of the rectified power decreases after having reached the peak in section t4˜t7, the driving current If is decreased in accordance with the decrease in the voltage V1 of the rectified power. When the voltage Vd detected from the decreased driving current If is lower than the second reference signal VR2 of the second comparator U2, that is, when it reaches time t7, the second comparator U2 may output the lower limit control signal LL to the switch controller 32′, and the switch controller 32′ may enable the fourth switch SW4 to be turned off and the third switch SW3 to be turned on in order to decrease the number of driven LED groups. In this case, the fourth LED group G4 is turned off and only the first to third LED groups G1, G2, and G3 are driven.

Subsequent operations are as detailed above with reference to FIGS. 2, 3A, 3B, and 3C and accordingly, will be omitted.

In view of a waveform of the driving current If shown in a lower portion of FIG. 5A, the driving current If may be maintained to be equal to or lower than the upper limit UL in section t4˜t7, including the peak in the voltage V1 of the rectified power.

On the other hand, the driving current If may accidently become equal to the upper limit current If (UL) of the first comparator U1 at the peak in the voltage V1 of the rectified power, due to variations in the voltage V1 of the rectified power or tolerance in driving voltage Vf of the respective LED groups.

In particular, in a case in which the waveforms of the driving voltage LED total Vf of the LED groups and the voltage V1 of the rectified power are maximally proximate by increasing the number of switches in order to improve driving efficiency, driving efficiency may be improved while a possibility that the driving current If becomes equal to the upper limit current If(UL) of the first comparator U1 in the section including the peak in the voltage V1 of the rectified power may be increased.

In this case, as illustrated in FIG. 6A, the first comparator U1 may output the upper limit control signal UL to the switch controller 32 to change a switch operation, such that the next stage may proceed. Alternately, as illustrated in FIG. 6B, the previous stage may be maintained as it is, without outputting the upper limit control signal UL.

At this point, there is no problem in the case in which the next stage proceeds (FIG. 6A) or the previous stage is maintained as it is (FIG. 6B). However, when different waveforms shown in FIGS. 6A and 6B are alternately exhibited, such as a case in which the next stage proceeds in one cycle and the previous stage is maintained in the next cycle, brightness changes may correspond to a frequency lower than 120 Hz or 100 Hz, thereby being recognized as flickering by human eyes.

Hereafter, circuit operations shown in FIGS. 6A and 6B are particularly explained.

Referring to FIG. 6A, operations of section t1′˜t4′ are similar to the operations of the section t1˜t4 shown in FIG. 5A. However, when the first to fourth LED groups G1, G2, G3, and G4 are driven in section t4′˜t5′, if the driving current If becomes equal to the upper limit current If (UL) of the first comparator U1, the first to fourth switches SW1, SW2, SW3, and SW4 are turned off so as to drive more LEDs, i.e., so that the first to fifth LED groups G1, G2, G3, G4, and G5 may be driven.

When the number of driven LEDs is increased, the driving current If may be instantly decreased (time t5′). In section t5′˜t6′, the driving current If is decreased as the voltage V1 of the rectified power decreases after having reached the peak. When the driving current If is lower than the lower limit current If (LL) of the second comparator U2, the switch controller 32 may enable the fourth switch SW4 to be turned on in order to drive fewer LEDs. Operations subsequent to time t6′ are similar to those subsequent to time t7 of FIG. 5.

Meanwhile, FIG. 6B shows similar operations to those of FIG. 5, except for section t5˜t6 of FIG. 5. The fifth LED group may not be turned on.

In order to prevent a flicker phenomenon due to the irregular exhibiting of the waveforms shown in FIGS. 6A and 6B, when the upper limit control signal UL is not output from the first comparator U1 during a certain period (section t4˜t5 in FIG. 5A) in a section from the time at which the upper limit control signal UL is initially output from the first comparator U1 (time t2) to the time at which the lower limit control signal LL is initially output from the second comparator U2, a dummy pulse may be forcibly generated to allow the next stage to proceed, such that a flicker phenomenon may be suppressed.

That is, when the driving current If becomes equal to the upper limit current If (UL) detected in the first comparator U1, the next stage proceeds to allow the driving current If to have the waveform shown in FIG. 6A, such that the flicker phenomenon caused by exhibiting different waveforms according to cycles may be prevented.

The driving control unit 30′ according to the present exemplary embodiment may allow the dummy pulse to be generated from the first comparator U1 (section t5˜t6) when the upper limit control signal UL is not output from the first comparator U1 during a certain period in a section from the time at which the upper limit control signal UL is initially output from the first comparator U1 (time t2) to the time at which the lower limit control signal LL is initially output from the second comparator U2, such that a flicker prevention operation may be performed in section t4˜t7 in which the voltage V1 of the rectified power is highest.

As illustrated in FIGS. 5A, 5B, and 5C, regardless of whether the driving current If becomes equal to the upper limit current If (UL) of the first comparator U1 in the section, including the peak in the voltage V1 of the rectified power (section in which the greatest number of LED groups are capable of being driven), when the next stage forcibly proceeds in the case in which there is no stage change, the fifth LED group G5 may be turned on at all the time within one cycle, such that the flicker phenomenon may be alleviated.

In this case, as illustrated in FIGS. 5A, 5B, and 5C, even in the case in which the driving current operates within a current range defined by the upper limit UL and the lower limit LL, all switches are forcibly turned off so as to drive the fifth LED group G5 at a predetermined time (time t5), such that the driving current If may flow through the first to fifth LED groups G1, G2, G3, G4, and G5. At this time, as the driving voltage Vf is increased by the fifth LED group G5, the driving current If is decreased. When the decreased driving current If is lower than lower limit current If (LL) of the second comparator U2, the switch controller 32 may control the switch so as to reduce driven LED groups, such that the next stage (section t6˜t7) in which the fourth switch SW4 is turned on and the first to fourth LED groups G1,G2,G3 and G4 are driven, proceeds.

That is, in the present exemplary embodiment, the dummy pulse is forcibly generated in the section including the peak in the voltage V1 of the rectified power to thereby proceed to the next stage, such that the flicker phenomenon occurring in the case in which the next stage proceeds or does not proceed according to each cycle may be suppressed.

Although a light emitting apparatus including a light source unit is described above, a power supply device supplying driving power to the light source unit, and a driving device may be provided according to another aspect.

The power supply device may supply driving power to the light source unit, detect a current flowing in the light source unit, and control the number of light sources driven in the light source unit to be changed when the detected current is outside of a predetermined current range.

The power supply device may be considered to be a configuration excluding the light source unit 20 or 20′ from the light emitting apparatus 100 or 101 shown in FIG. 2 or FIG. 4. As described above, the power supply device may not include the rectifying unit 10 or 10′ rectifying an external AC power into DC power.

In addition, according to another aspect, the light emitting apparatus may include a driving device IC for driving the light source unit 20 or 20′. The driving device IC may include: a comparator comparing an input signal with a reference signal and outputting a control signal when the detected current is outside of a predetermined current range; and a switch controller receiving the control signal output from the comparator and outputting a signal for changing the number of driven light sources when receiving the control signal.

In this case, the driving device IC may be understood to be an IC region (the voltage regulator, the switch controller 32, and the comparator 31) denoted by a dotted line in the light emitting apparatus 100 or 101 according to the exemplary embodiment shown in FIG. 2 or FIG. 4. The voltage regulator may be omitted.

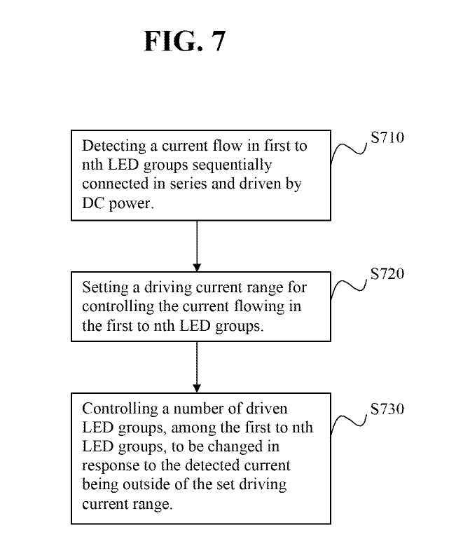

FIG. 7 illustrates a flowchart of an LED driving method according to an exemplary embodiment. Referring to FIG. 7, in operation S710, a current flow in first to nth LED groups sequentially connected in series and driven by DC power is detected. In operation S720, a driving current range for controlling the current flowing in the first to nth LED groups is set. In operation S730, a number of driven LED groups is controlled to be changed in response to the detected current being outside of the set (or a predetermined) driving current range.

As set forth above, according to exemplary embodiments, a light emitting apparatus having a low cost and high efficiency and an LED driving method using the same can be provided.

While exemplary embodiments have been shown and described above, it will be apparent to those skilled in the art that modifications and variations can be made without departing from the spirit and scope of the invention as defined by the appended claims.

What is claimed is:

1. A light emitting apparatus, comprising:
a light source comprising first to nth light emitting device (LED) groups driven by direct current (DC) power and sequentially connected in series; and
a driving controller which detects a current flowing in an output terminal of the light source and changes a number of LED groups, among the first to nth LED groups, driven in the light source in response to the detected current being outside of a predetermined current range.

2. The light emitting apparatus of claim 1, wherein the driving controller detects the current flowing in the output terminal of the light source to generate an input signal, and compares the input signal with a reference signal to determine whether the detected current is outside of the predetermined current range.

3. The light emitting apparatus of claim 1, wherein the driving controller comprises:
a comparator which compares an input signal generated by detecting the current flowing in the light source unit with a reference signal and outputs a control signal in response to the detected current being outside of the predetermined current range;
a switch controller which receives the control signal output from the comparator and outputs a signal for changing the number of driven LED groups in response to receiving the control signal; and
a switch connected to at least a portion of output terminals of the first to nth LED groups and turned on or turned off by the signal output from the switch controller.

4. The light emitting apparatus of claim 3, wherein the comparator outputs an upper limit control signal or a lower limit control signal in response to the current detected in the output terminal of the light source being outside of the predetermined current range.

5. The light emitting apparatus of claim 4, wherein the switch controller outputs a first signal for increasing the number of driven LED groups in response to receiving the upper limit control signal and outputs a second signal for decreasing the number of driven LED groups in response to receiving the lower limit control signal.

6. The light emitting apparatus of claim 4, wherein the driving controller further comprises a flicker prevention circuit which controls the switch to be forcibly turned off in response to the upper limit control signal not being output during a certain period in a section from a time at which the upper limit control signal is initially output to a time at which the lower limit control signal is initially output, in a driving cycle of the DC power.

7. The light emitting apparatus of claim 3, wherein the comparator comprises:
a first comparator which compares the input signal with a first reference signal and outputs an upper limit control signal in response to the input signal being greater than the first reference signal; and
a second comparator which compares the input signal with a second reference signal and outputs a lower limit control signal in response to the input signal being lower than the second reference signal.

8. The light emitting apparatus of claim 7, wherein:
the first comparator and the second comparator are comparators or operational amplifiers (OP amps);
an inverting input terminal of the first comparator receives the first reference signal, and a non-inverting input terminal of the first comparator receives the input signal; and
an inverting input terminal of the second comparator receives the input signal, and a non-inverting input terminal of the second comparator receives the second reference signal.

9. The light emitting apparatus of claim 8, further comprising:
a voltage regulator which receives a part of the DC power and outputs a certain level of voltage; and
a plurality of resistors connected in series between an output terminal of the voltage regulator and a ground,
wherein the first reference signal and the second reference signal are set to be voltages divided by the plurality of resistors.

10. The light emitting apparatus of claim 3, wherein:
the comparator further includes a current detection resistor connected between the output terminal of the light source unit and a ground, and the input signal is generated in a voltage form by the current detection resistor; and
the switch comprises first to (n−1)th switches, respectively connected between output terminals of first to (n−1)th LED groups and the current detection resistor.

11. An LED driving method, comprising:
detecting a current flowing in first to nth LED groups sequentially connected in series and driven by DC power;
setting a driving current range for controlling the current flowing in the first to nth LED groups; and
controlling a number of driven LED groups, among the first to nth LED groups, to be changed in response to the detected current being outside of the set driving current range.

12. The LED driving method of claim 11, wherein the setting the driving current range comprises setting the driving current range to have an upper limit of current and a lower limit of current.

13. The LED driving method of claim 12, wherein the controlling the number of driven LED groups to be changed comprises:
controlling the number of driven LED groups to be increased in response to the current flowing in the first to nth LED groups being greater than the upper limit; and
controlling the number of driven LED groups to be decreased in response to the current flowing in the first to nth LED groups being lower than the lower limit.

14. The LED driving method of claim 12, further comprising:
controlling the number of driven LED groups to be forcibly changed in response to the detected current being within the set driving current range during a certain period in a section from a time at which the current flowing in the first to nth LED groups is initially greater than the upper limit to a time at which the current flowing in the first to nth LED groups is initially lower than the lower limit, in a driving cycle of the DC power.

15. The LED driving method of claim 14, wherein the controlling the number of driven LED groups to be forcibly changed comprises controlling the number of driven LED groups to be increased in response to the detected current being within the set driving current range during the certain period.

16. The LED driving method of claim 11, wherein the first to nth LED groups are controlled such that the first to nth LED groups are sequentially turned on and then nth LED group to the first LED group are sequentially turned off, in a driving cycle of the DC power.

17. An LED driving method, comprising:
detecting a current flowing in first to nth LED groups sequentially connected in series and driven by DC power; and
controlling a number of driven LED groups, among the first to nth LED groups, to be changed in response to the detected current being outside of a predetermined current range.

18. The LED driving method of claim 17, further comprising:
generating an input signal according to the detected current; and
comparing the input signal with a reference signal to determine whether the detected current is outside of the predetermined current range.

19. The LED driving method of claim 18, wherein the comparing comprises outputting an upper limit control signal or a lower limit control signal in response to the detected current being outside of the predetermined current range.

20. The LED driving method of claim 19, wherein the controlling the number of driven LED groups comprises:
controlling the number of driven LED groups to be increased in response the upper limit control signal being output in the outputting; and
controlling the number of driven LED groups to be decreased in response to the lower limit control signal being output in the outputting.
